(19) United States
(12) Patent Application Publication
(10) Pub. No.: US 2009/0021435 A1
(43) Pub. Date: Jan. 22, 2009

(54) GLASS ANTENNA FOR VEHICLE

(76) Inventor: Yong Shik SHIN, Siheung-si (KR)

Correspondence Address: IPLA P.A., 3580 WILSHIRE BLVD., 17TH FLOOR, LOS ANGELES, CA, 90010, US

(21) Appl. No.: 12/174,304

(22) Filed: Jul. 16, 2008

(30) Foreign Application Priority Data
Jul. 16, 2007 (KR) 20-2007-0011719

(51) Int. Cl. H01Q 1/32

(52) U.S. Cl. 343/713

(57) ABSTRACT

A glass antenna for vehicle comprising: a first antenna, a part of which are formed at the edge of vehicle glass to the clockwise direction, and the other part of which is obliquely tilted in the vehicle glass; a second antenna which faces opposite direction to said first antenna; a third antenna, a part of which is parallelly spaced from said second antenna, and the other part of which is obliquely tilted in said vehicle glass; a fourth antenna which is connected with said first antenna and formed plurally tilted in said vehicle glass obliquely; a feed point disposed at the glass frame and connected to said first antenna and second antenna to transmit the signal to receiver. Accordingly, by improving the directivity of said antenna, it's possible to gain more stable receive sensitivity during moving, and antenna length can be extended at limited area.

### CROSS REFERENCE

This application claims foreign priority under Paris Convention and 35 U.S.C. § 119 to Korean Patent Application No. 20-2007-0011719, filed Jul. 16, 2007 with the Korean Intellectual Property Office.

### BACKGROUND OF THE INVENTION

The present utility relates to an glass antenna for vehicle, and more particularly, antenna pattern formed on of vehicle glass obliquely tilted by specific degrees of angle to improve directivity of antennas, and makes it possible to gain more stable receiving sensitivity while moving of the vehicle.

Generally, vehicle antennas are installed in front fender of vehicle or rear quarter in pole type, but this pole type antenna mechanically breaks down frequently, and deteriorates the electric wave receiving rate while moving fast, and because it projects outwardly from the body of vehicle, there is a problem of cracking and snapping.

Therefore, recently, it's universal to compose antenna pattern with thin plate shapes on the vehicle glass, that is named ‘glass antenna’, to solve said pole type antenna's problem.

To form glass antenna for vehicle, thin conducting wires which have thickness lower than 0.3 mm are inserted into the middle layer of two glasses commissure or are printed on the surface of rear glass.

Here, at high frequency region, glass is regard as insulator like air, so, it functions like a holder that holds conducting wire in the air, and pattern of glass antenna is subtly affected by shape of vehicle body or glass.

Conventional glass antenna was formed in commissure of glasses or on surface of glass in shape of plural number of crossing horizontal conducting wire and vertical conducting wire, and feed point was composed at outside of rear glass, in other words, the lower part of glass antenna, and connected with antenna.

The function of conventional glass antenna is to receive broadcasting electric wave and transmit it to receiving terminal of radio through said feed point for good receiving performance.

However, said conventional glass antenna which has a structure of horizontally and vertically crossed conducting wire has good performance at stand still state, but while vehicle's moving, receiving performance of glass antenna deteriorates very much because the receiving sensitivity changes in large range.

Moreover, when said structure of horizontally and vertically crossed conducting wire is composed at narrow glass area like side glass of vehicle, it's hard to form suitable length of conducting wire for receiving electric wave frequency because of limited area.

### SUMMARY OF THE INVENTION

Accordingly, the purpose of the present utility is to solve above-described problems, and is to provide glass antenna for vehicle which comprise obliquely tilted part by specific degrees of angle to improve directivity of antennas, and make it possible to gain more stable receive sensitivity while moving.

Another purpose of the present utility is to provide glass antenna for vehicle, which can secure suitable antenna length for receiving electric wave frequency at limited area like a side glass of vehicle.

To achieve said object according to present utility, glass antenna for vehicle according to present utility comprising: a first antenna, a part of which are formed at the edge of vehicle glass to the clockwise direction, and the other part of which is obliquely tilted in the vehicle glass, and resonates with lower frequency range than FM frequency band; a second antenna which faces opposite direction to said first antenna and resonates with upper frequency range than FM frequency band; a third antenna, a part of which is parallelly spaced from said second antenna, and the other part of which is obliquely tilted in said vehicle glass, and resonates with FM frequency band; a fourth antenna which is connected with said first antenna and formed plurally tilted in said vehicle glass obliquely; a feed point disposed at the glass frame and connected to said first antenna and second antenna to transmit the signal to receiver.

Here, said a part of first antenna which is obliquely tilted in the vehicle glass tilts from 43 to 47 degrees of angle with regard to the horizontal line of vehicle glass.

Also, said a part of third antenna which is obliquely tilted in vehicle glass can be formed to tilt from 43 to 47 degrees of angle with regard to the horizontal line of vehicle glass.

Also, said fourth antenna can be formed to tilt from 43 to 47 degrees of angle with regard to the horizontal line of vehicle glass.

Preferably, said first antenna can be formed to have length approximately ¾ of FM frequency wavelength.

Also, said third antenna can be formed to have length approximately ¼ of FM frequency wavelength.

Also, said glass antenna can be formed in the side glass of vehicle.

As mentioned above, by the glass antenna for vehicle according to present utility which comprise obliquely tilted part by specific degrees of angle, directivity of antennas can be improved so, it is possible to gain more stable receive sensitivity during moving.

Also, by the glass antenna for vehicle according to present utility, it is possible to secure suitable antenna length for receiving electric wave frequency at limited area like a side glass of vehicle.

### BRIEF DESCRIPTION OF THE DRAWINGS

FIG. 1 is front view of glass antenna for vehicle according to present utility.

FIG. 2 graphically shows the radiation characteristic of glass antenna for vehicle according to present utility in FM frequency band.

FIG. 3 graphically shows the VSWR (Voltage Standing Wave Ratio) characteristic of glass antenna for vehicle according to present utility in FM frequency band.

### DETAILED DESCRIPTION OF THE INVENTION

Hereinafter, the present utility is described in detail with reference to the attached drawings.

Before the detailed description, it should be noted that the terms used in the present specification and the claims are not to be limited to their lexical meanings, but are to be interpreted to conform with the technical idea of the present utility under the principle that the inventor can properly define the terms for the best description of the utility made by the inventor.

Therefore, the embodiments and the constitution illustrated in the attached drawings are merely preferable embodiments according to the present utility, and thus they do not express all of the technical idea of the present utility, so that it should be understood that various equivalents and modifications can exist which can replace the embodiments described in the time of the application.

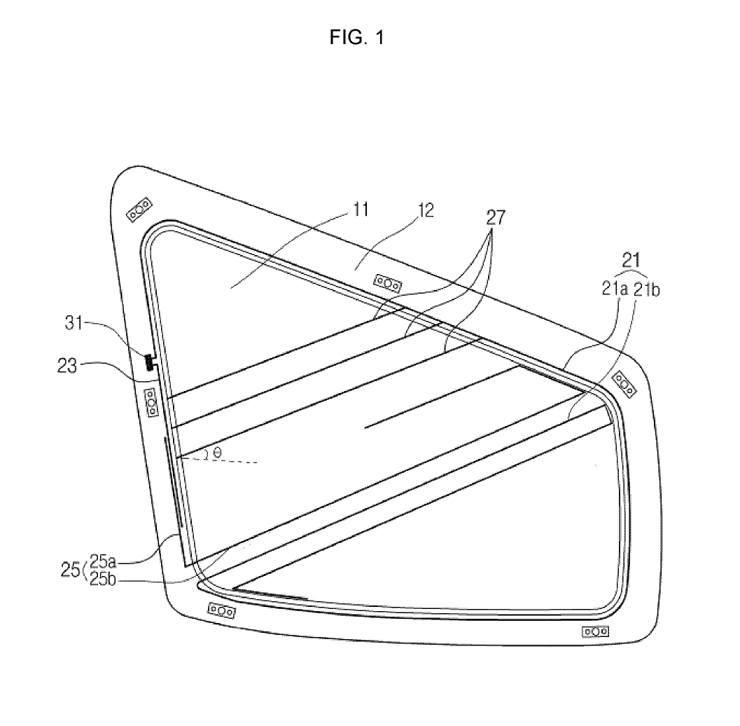

FIG. 1 is front view of glass antenna for vehicle according to present utility.

Referring to FIG. 1, glass antenna for vehicle according to present utility comprising: a first antenna (21), a part of which are formed at the edge of vehicle glass (11) to the clockwise direction, and the other part of which is obliquely tilted in the vehicle glass (11), and resonates with lower frequency range than FM frequency band; a second antenna (23) which faces opposite direction to said first antenna (21) and resonates with upper frequency range than FM frequency band; a third antenna (25), a part of which is parallelly spaced from said second antenna (23), and the other part of which is obliquely tilted in said vehicle glass (11), and resonates with FM frequency band; a fourth antenna (27) which is connected with said first antenna (21) and formed plurally tilted in said vehicle glass (11) obliquely; a feed point (31) disposed at the glass frame and connected to said first antenna (21) and second antenna (23) to transmit the signal to receiver.

Here, glass antenna for vehicle composed as said above can be disposed at the side glass of vehicle.

Said first antenna (21) is the main antenna pattern portion of glass antenna for vehicle, and preferably the length of said first antenna (21) is formed in extended pattern to be able to receive uniform frequency band.

Accordingly, a part of said first antenna (21) surrounds the edge of vehicle glass (11), and the other part are formed inside of said vehicle glass (11) in plural continuous oblique line form.

Here, a part said first antenna (21) which disposed inside of said vehicle glass is tilted by an particular angle θ, and this angle should be the angle that can complement the directivity of electric wave to improve the receive sensitivity.

Therefore, suitable angle for improvement of the receive sensitivity of said first antenna (21) is from 43 to 47 degrees of angle with regard to the horizontal line of said vehicle glass (11), preferably, the angle suitable for best receive sensitivity can be 45 degrees of angle with regard to the horizontal line of said car glass (11).

Said first antenna (21) is directly connected with said feed point (31), so, electric wave received from said first antenna (21) can immediately be transmitted to electric wave receiver through the feed point (31).

Here, said first antenna (21) resonates with lower frequency range than FM frequency band, therefore, the length of said first antenna (21) is formed to be ¾ of FM frequency wavelength.

Therefore, by said first antenna (21) resonating with lower range of FM frequency band, glass antenna for vehicle according to present utility can be composed in broadband antenna which can receive electric wave besides to FM frequency band, so, it can minimize an outer interference while the antenna receives FM frequency band.

The second antenna (23) is the sub antenna pattern component of glass antenna for vehicle, and it is formed to be able to receive high frequency band.

In other words, said second antenna (23) resonate at upper frequency range than FM frequency band to complement the receive sensitivity of high frequency band of said first antenna (21) which resonate at low frequency band.

Therefore, by said second antenna (23) which resonate at upper frequency range than FM frequency band, glass antenna for vehicle according to present utility is composed in broadband antenna which can receive electric wave besides to FM frequency band, so, it can minimize an outer interference while the antenna receives FM frequency band.

Accordingly, to receive short wave which is over the FM frequency, said second antenna (23) is formed to be short straight line pattern and faces opposite direction to said first antenna (21) from the said feed point (31).

Here, said second antenna (23) is directly connected with said feed point (31), so, electric wave received from second antenna (23) can be immediately transmitted to electric wave receiver through the feed point (31).

The third antenna (25) is formed to be coupling pattern with said second antenna (23) and resonate to FM frequency band.

A part of said third antenna (25) is separated from said second antenna (23) parallelly, the other part of said third antenna is obliquely tilted to be disposed inside said vehicle glass (11).

Here, a part of said third antenna (25) is parallelly separated from said second antenna (23) and composes coupling capacitor with second antenna (23), and this coupling capacitor make it possible to improve the receive rate of third antenna (25) and second antenna (23) because of frequency resonance.

And, by said coupling capacitor, glass antenna for vehicle according to present utility can minimize outer interference during receiving FM frequency band.

Preferably, in said third antenna (25), resonance of coupling capacitor can be composed to resonate to FM frequency band.

And, said third antenna (25) can be formed to have ¼ length of FM frequency wavelength for being resonated with FM frequency band,

Here, in said third antenna (25), a part which is disposed inside said glass (11) is tilted by particular angle θ, and this angle should complement the directivity of electric wave to improve the receive sensitivity.

Therefore, suitable angle for improvement of the receive sensitivity of said third antenna (25) is from 43 to 47 degrees of angle with regard to the horizontal line of said vehicle glass (11), preferably, most suitable angle for best receive sensitivity is 45 degrees of angle with regard to the horizontal line of said vehicle glass (11).

The fourth antenna (27) is formed as sub pattern to improve the receive sensitivity of said first antenna (21).

Said fourth antenna (27) is connected with said first antenna (21), and formed plurally inside said vehicle glass (11) and obliquely tilted to complement the directivity of electric wave which is received at said first antenna (21).

Here, said fourth antenna (27) is tilted by an particular angle θ, and this angle should complement the directivity of electric wave to improve the receive sensitivity.

Therefore, suitable angle for improvement of the receive sensitivity of said fourth antenna (27) is from 43 to 47 degrees of angle with regard to the horizontal line of said glass (11), preferably, suitable angle for best receive sensitivity can be 45 degrees of angle with regard to the horizontal line of said car glass (11).

Feed point (31) transmits the electric wave which is received at said glass antenna for vehicle to electric wave receiver like radio or TV, etc.

Here. said feed point (31) is deposed at one side of said glass frame of vehicle, and directly connected with said first antenna (21) and second antenna (23).

Said third antenna (25) and fourth antenna are not directly connected with said feed point (31), but said third antenna (25) composes the coupling pattern with second antenna (23), consequently, electric wave received from said third antenna (25) is transmitted to said feed point (31) through the second antenna (23).

And, said fourth antenna (27) is connected with said first antenna (21), accordingly, electric wave received from fourth antenna (27) is transmitted to said feed point (31).

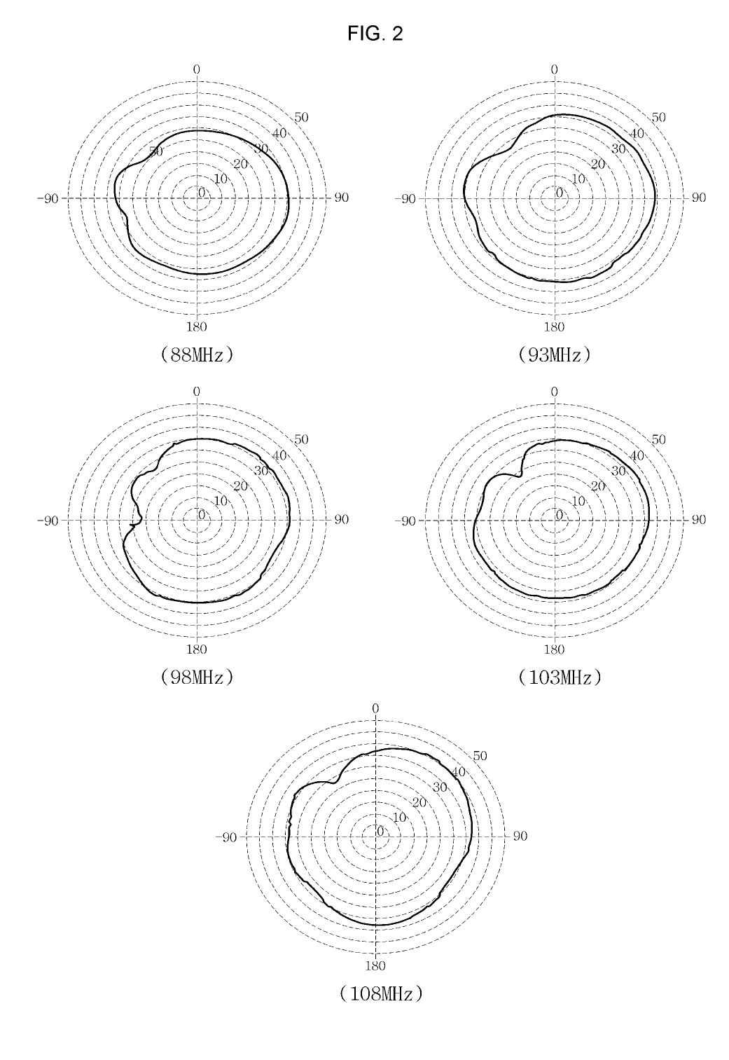

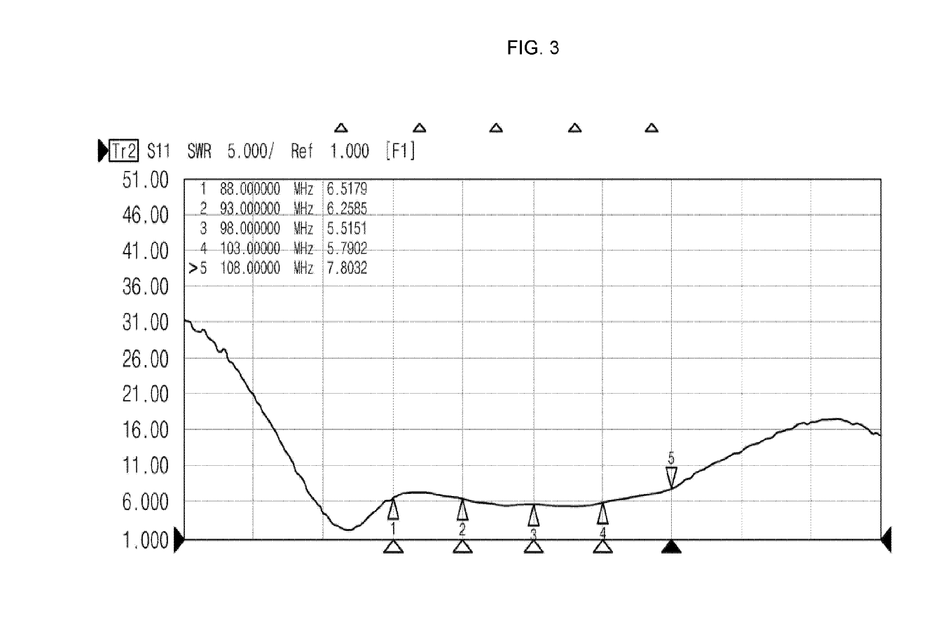

Hereinafter, referring to FIG. 2 and FIG. 3, characteristic of glass antenna for vehicle according to present utility composed as above is as follows.

Here, FIG. 2 graphically shows the radiation characteristic in FM frequency band of glass antenna for vehicle according to present utility and FIG. 3 graphically shows the VSWR (Voltage Standing Wave Ratio) characteristic in FM frequency band of glass antenna for vehicle according to present utility.

Here, said VSWR is ratio of maximum amplitude to minimum amplitude of standing wave which is generated by reflection, and, if there is no reflection, VSWR goes to 1, and as reflection grows bigger, VSWR goes to infinity.

Referring to FIG. 2, by measuring an radiation pattern of 88 MHz, 93 MHz, 98 MHz, 103 MHz, 108 MHz which is in range of FM frequency band, said glass antenna is ideal to receiving FM signal, because gain characteristic in angle of −45 degrees is slightly deteriorated, but it generally shows uniform gain characteristic in shape of concentric circle.

Referring to FIG. 3, VSWR of glass antenna for vehicle according to present utility shows generally uniform and low value, in the range from 6 to 8.

Therefore, owing to small return loss in said frequency band which is FM frequency band, glass antenna for vehicle according to present utility is good antenna for receiving the electric wave.

What is claimed is:

1. Glass antenna for vehicle comprising:
a feed point disposed at the glass frame and connected to antenna to transmit the signal to receiver;
a first antenna, a part of which starts from said feed point at the edge of vehicle glass to the clockwise direction, and the other part of which is obliquely tilted in the vehicle glass, and resonates with lower frequency range than FM frequency band;
a second antenna formed in straight shape and faces opposite direction to said first antenna from said feed point, and resonates with upper frequency range than FM frequency band;
a third antenna, a part of which is parallelly spaced from said second antenna, and the other part of which is obliquely tilted in said vehicle glass, and resonates with FM frequency band;
a fourth antenna which is connected with said first antenna and formed plurally tilted in said vehicle glass obliquely.

2. Glass antenna for vehicle according to claim 1, wherein said a part of first antenna which is obliquely tilted in the vehicle glass tilts from 43 to 47 degrees of angle with regard to the horizontal line of vehicle glass.

3. Glass antenna for vehicle according to claim 1, wherein said a part of third antenna which is obliquely tilted in vehicle glass tilts from 43 to 47 degrees of angle with regard to the horizontal line of vehicle glass.

4. Glass antenna for vehicle according to claim 1, wherein said fourth antenna tilts from 43 to 47 degrees of angle with regard to the horizontal line of vehicle glass.

5. Glass antenna for vehicle according to claim 1, wherein said first antenna is formed to have length approximately ¾ of FM frequency wavelength.

6. Glass antenna for vehicle according to claim 1, wherein said third antenna is formed to have length approximately ¼ of FM frequency wavelength.

7. Glass antenna for vehicle according to claim 1, wherein said glass antenna is formed in the side glass of vehicle.
